(19) United States
(12) Patent Application Publication
(10) Pub. No.: US 2023/0347288 A1
(43) Pub. Date: Nov. 2, 2023

(54) SELECTIVE CATALYTIC REDUCTION CATALYST AND CATALYTIC ARTICLE COMPRISING THE SAME

(71) Applicant: BASF CORPORATION, Florham Park, NJ (US)

(72) Inventors: Yuchao ZHANG, Shanghai (CN); Renjie QIU, Shanghai (CN); Jia Di ZHANG, Shanghai (CN)

(21) Appl. No.: 17/997,831

(22) PCT Filed: Apr. 26, 2021
(86) PCT No.: PCT/CN21/29084

§ 371 Date: Nov. 3, 2022

(30) Foreign Application Priority Data
May 15, 2020 (WO) PCT/CN2020/090595

(51) Int. Cl. B01D 53/94; B01J 23/22; B01J 21/08; B01J 35/00; B01J 35/04; B01J 37/04; B01J 37/02; B01J 37/00; F01N 3/20; F01N 3/28; F01N 3/035; F01N 3/10

(52) U.S. Cl. CPC B01D 53/9418; B01J 23/22; B01J 21/08; B01J 35/0066; B01J 35/04; B01J 37/04; B01J 37/0236; B01J 37/0221; B01J 37/0228; B01J 37/024; B01J 37/0009; F01N 3/2066; F01N 3/2825; F01N 3/035; F01N 3/106; B01D 2257/404; B01D 2255/20723; B01D 2255/2098; B01D 2251/2062; B01D 2258/01; F01N 2370/04; F01N 2610/02

(57) ABSTRACT

The present invention relates to a selective catalytic reduction (SCR) catalyst comprising a support, vanadium and antimony, a catalytic article comprising the SCR catalyst, and an exhaust treatment system for an internal combustion engine comprising the SCR catalyst. In one embodiment, the invention provides an SCR catalyst for reduction of 5 nitrogen oxides, comprising: a support, and an active material on the support; wherein the support, calculated as its oxide, is present in the SCR catalyst in an amount of 40 to 99% by weight, relative to the total weight of the SCR catalyst; the active material comprises vanadium and antimony; the vanadium, calculated as V₂O₅, is present in the SCR catalyst in an amount of 1 to 15% by weight, relative to the total weight of the SCR catalyst; the 10 antimony, calculated as Sb₂O₃, is present in the SCR catalyst in an amount of 0.5 to 20% by weight, relative to the total weight of the SCR catalyst; wherein the SCR catalyst, after hydrothermally aged at 550° C. for 100 hours with 10% water, has a 200-300° C. denitrification efficiency of at least 60%, with 60,000h⁻¹ space velocity and an ammonia to NOx molar ratio of 1:11

### FIELD OF THE INVENTION

The present invention relates to a selective catalytic reduction (SCR) catalyst comprising a support, vanadium and antimony, a catalytic article comprising the SCR catalyst, and an exhaust treatment system for an internal combustion engine comprising the SCR catalyst.

### BACKGROUND

Nitrogen oxides, also referred to as NOx, emitted as exhaust gases from mobile source such as vehicles and stationary source such as power plants would be harmful to environment and human beings. In order to remove NOx from exhaust gases, catalytic reduction methods have heretofore been developed. The catalytic reduction methods are suitable for dealing with large quantities of exhaust gases, and of these, selective catalytic reduction (SCR) is a means of converting NOx with the aid of an SCR catalyst into nitrogen (N₂) and water (H₂O) in the presence of a reductant source. The reductant source can be hydrocarbon, ammonia, urea, etc. that exists in the exhaust gas of a diesel engine or is added to a stream of exhaust gas of a diesel engine. Among them, the reductant source is usually automotive-grade urea, otherwise known as Diesel Exhaust Fluid (DEF). The urea undergoes the hydrolysis reaction (urea plus water produces ammonia and carbon dioxide) to deliver ammonia into the exhaust flow. A process comprising adding ammonia (or urea) as a reducing agent to catalytically reduce NOx selectively to N₂ was reported to be superior. Various catalysts useful for selective catalytic reduction, also called SCR catalysts, have been developed for abatement of NOx from the stationary and mobile sources. The SCR catalysts are required to reduce NOx over a broad temperature range and especially at a temperature as low as possible below 300° C.

Among various SCR catalysts, a group of catalysts with vanadium oxides as active species (V SCR catalysts) is of particular interest for their low cost and sulfur resistance during a NOx abatement process. Generally, V SCR catalysts comprise one or more promoters to provide improved catalyst performances. For example, V SCR catalysts containing an oxide of tungsten or molybdenum as a promoter have been widely studied for several decades, as described in U.S. Pat. No. 3,279,884A, EP0272620A2, EP0348768A2, CA2899929A, CN103736497A, U.S. Pat. No. 7,507,684B2, US2014/0157763A1, WO2010/099395A1, WO2013/179129A2, WO2013/017873A1.

Due to the needs of further reducing cost and improving catalyst performance for abatement of NOx, V SCR catalysts with alternative promoters were developed. One of the alternative promoters of interest is antimony. Such V SCR catalysts with antimony as a promoter were described, for example, in KR101065242B1, US2009/143225A1, and WO2017101449A1.

KR101065242B1 discloses a V SCR catalyst prepared by a process which comprises mixing a vanadium precursor and an antimony precursor into a slurry containing TiO₂ sol and calcining the obtained slurry at 500° C. or lower temperature. It was described that the V SCR catalyst with antimony as the promoter has good NOx abatement efficiency and sulfur poisoning resistance at low temperatures.

US2009/143225A1 discloses a V SCR catalyst comprising metal oxide supporters, vanadium as the active material and antimony as the promoter. The V SCR catalyst was prepared by impregnation of TiO₂ with precursors containing vanadium and antimony or other conventional catalyst synthesis methods such as sol gel method. It was described that the V SCR catalyst can promote reduction of NOx at low temperatures and increase sulfur poisoning resistance.

WO2017101449A1 discloses a SCR catalyst prepared from a process which comprises mixing a vanadium/antimony oxide and optionally a silicon source with a support comprising TiO₂ in a solvent to obtain a suspension, drying and calcining. The vanadium/antimony oxide was prepared by providing a suspension comprising vanadium oxide(s) and antimony oxide(s), and drying.

### SUMMARY OF THE INVENTION

The present invention relates to a selective catalytic reduction (SCR) catalyst comprising a support, vanadium and antimony.

Aspects include SCR catalysts for reduction of nitrogen oxides, comprising: a support, and an active material on the support.

Other aspects include methods for preparing the SCR catalysts, methods for treatment of exhaust gas from internal combustion engines, and methods for testing Nox.

Other aspects include SCR catalytic articles comprising the SCR catalysts, and exhaust treatment systems for internal combustion engines.

### DETAILED DESCRIPTION OF THE INVENTION

Before describing several exemplary embodiments of the invention, it is to be understood that the invention is not limited to the details of construction or process steps set forth in the following description. The invention is capable of other embodiments and of being practiced or being carried out in various ways.

With respect to the terms used in this disclosure, the following definitions are provided.

Throughout the description, including the claims, the term “comprising one” or “comprising a” should be understood as being synonymous with the term “comprising at least one”, unless otherwise specified, and “between” or “to” should be understood as being inclusive of the limits.

The terms “a”, “an” and “the” are used to refer to one or to more than one (i.e., to at least one) of the grammatical object of the article.

The term “and/or” includes the meanings “and”, “or” and also all the other possible combinations of the elements connected to this term.

All percentages and ratios are mentioned by weight unless otherwise indicated.

### SCR Catalyst

The present invention provides an SCR catalyst for reduction of nitrogen oxides (NOx), comprising: a support, and an active material on the support;
wherein the support, calculated as its oxide, is present in the SCR catalyst in an amount of 40 to 99% by weight, relative to the total weight of the SCR catalyst;
wherein the active material comprises vanadium and antimony; the vanadium, calculated as V₂O₅, is present in the SCR catalyst in an amount of 1 to 15% by weight, relative to the total weight of the SCR catalyst; the antimony, calculated as Sb₂O₃, is present in the SCR catalyst in an amount of 0.5 to 20% by weight, relative to the total weight of the SCR catalyst;
wherein the SCR catalyst, after hydrothermally aged at 550° C. for 100 hours with 10% water, has a 200-300° C. denitrification efficiency of at least 60%, with 60,000 h⁻¹ space velocity and an ammonia to NOx molar ratio of 1:1.

In one or more embodiments, the SCR catalyst, after thermally aged at 600° C. for 50 hours, has a 200-300° C. denitrification efficiency of at least 50%, with 60,000 h⁻¹ space velocity and an ammonia to NOx molar ratio of 1:1.

In one or more embodiments, the support can be a metal oxide of Ti, Si, W, Al, Ce, Zr, Mg, Ca, Ba, Y, La, Pr, Nb, Mo, Mn, Fe, Co, Ni, Cu, Zn, Ga, Sn, Bi, or a mixture of any two or more of these oxides. Alternatively, or in addition, the support can comprise a molecular sieve. The molecular sieve can be a silicate zeolite, an aluminosilicate zeolite, a metal-substituted aluminosilicate zeolite or a non-zeolitic molecular sieve.

In some embodiments, at least a portion of the metal oxides listed above in the support can also act as additives such as binder, dispersant, filler, stabilizers, promoter, etc.

The amount of the additive depends on the form of the finished catalysts. The amount of the additive, expressed as the oxides of respective species to be incorporated into the SCR catalyst in total, is generally in the range of 1 to 30 wt %, preferably 1 to 15 wt % in the case that the finished SCR catalysts are in form of coated substrate which will be described hereinbelow, and is generally in the range of 1 to 90 wt % preferably 5 to 60 wt %, more preferably 10 to 50 wt % in the case that the finished catalysts are in form of shaped bodies. Respective amount of each additive, if more than one additive is used, is not critical for the purpose of the present invention.

In some embodiments, the support comprises at least one of TiO₂, SiO₂, WO₃, CeO₂, Al₂O₃ and ZrO₂. In specific embodiments, the support comprises TiO₂, and/or SiO₂. In more specific embodiments, the support comprises TiO₂ and SiO₂, the SiO₂, is present in an amount of 1 to 20% by weight, preferably 2.5 to 15% by weight, and more preferably 3 to 10% by weight, relative to the total weight of the support.

In some embodiments, the support consists of TiO₂, of TiO₂ and SiO₂, of TiO₂ and WO₃, of TiO₂, SiO₂ and WOs, of TiO₂ and CeO₂, of TiO₂, WO₃ and CeO₂, of TiO₂ and Al₂O₃ or of TiO₂ and ZrO₂. TiO₂ to be used in the present invention may be commercially available or prepared via conventional methods known in the art. In specific embodiments, TiO₂ to be used in the present invention is in the form of anatase.

In more specific embodiments, wherein SiO₂ is used in the support, and the finished SCR catalysts are in form of coated substrate, the amount of SiO₂ is in a range of 1 to 20% by weight, preferably 2.5 to 15% by weight, and more preferably 3 to 10% by weight, relative to the total weight of the support.

In some embodiments, the molecular sieve belongs to structure type AFG, AST, DOH, FAR, FRA, GIU, LIO, LOS, MAR, MEP, MSO, MTN, NON, RUT, SGT, SOD, SVV, TOL, UOZ, ABW, ACO, AEI, AEN, AFN, AFT, AFV, AFX, ANA, APC, APD, ATN, ATT, ATV, AVL, AWO, AWW, BCT, BIK, ERE, CAS, CDO, CHA, DDR, DFT, EAB, EDI, EDI, EPI, ERI, ESV, ETL, GIS, GOO, IFY, IHW, IRN, ITE, ITW, JBW, JNT, JOZ, JSN, KFI, LEV, -LIT, LTA, LTJ, LTN, MER, MON, MTF, MWF, NPT, NSI, NSOWE, PAU, TSC, RHO, RTH, PHR, SAS, SBV, SAUFN, SAVE, SUI, UGI, ZOI, CHI, LOV, NAB, NAT, RSN, STT, VSV, FER, MEL, MFI, MTT, MWW, SZR, AFI, AFR, AFS, AFY, ASV, ATO, ATS, BEA, BEC, BOG, BPH, CAN, CON, CZP, DFO, EMT, EON, EZT, FAU, GME, GON, IFR, ISV, IWR, IWV, IWW, LTL, MAZ, MEI, MOR, MOZ, MSE, MTW, NPO, OFF, OSI, -RON, RWY, SAO, SBE, SBS, SBT, SFE, SFO, SOS, SSY, USI or VET.

In one or more embodiments, the support calculated as metal oxides or molecular sieves, is present in the SCR catalyst in an amount of 50 to 90% by weight, preferably 60 to 85% by weight, including 65, 70, 75 and 80% by weight, relative to the total weight of the SCR catalyst.

In one or more embodiments, the vanadium, calculated as V₂O₅, is present in the SCR catalyst in an amount of 4 to 12% by weight, preferably 5 to 10% by weight, including 6, 7, 8 and 9% by weight, relative to the total weight of the SCR catalyst.

In one or more embodiments, the antimony, calculated as Sb₂O₃, is present in the SCR catalyst in an amount of 3 to 16% by weight, preferably 4 to 14% by weight, including 5, 6, 7, 8, 9, 10, 11, 12 and 13% by weight, relative to the total weight of the SCR catalyst.

In one or more embodiment, vanadium and antimony are present in a molar ratio V/Sb in the range of from 8:1 to 1:8, preferably from 4:1 to 1:4, more preferably from 2:1 to 1:2, calculated as respective elements.

In one or more embodiment, the SCR catalyst further comprises a platinum group metal (PGM). In some embodiments, the PGM is selected from the group consisting of platinum (Pt), palladium (Pd), rhodium (Rh) and mixtures thereof. It is to be understood that these terms embrace not only the metallic form of these PGMs, but also any metal oxide forms that are catalytically active for emissions reduction. Combinations of metallic and catalytically active metal oxide forms are also contemplated by the invention.

### Method for Preparing the SCR Catalyst

The present invention also provides a method for preparing an SCR catalyst, comprising steps of:
1) adding an antimony precursor in DI water, and stirring to obtain an antimony suspension in a temperature range of 50 to 150° C.;
2) adding a vanadium precursor into the antimony suspension obtained in step 1), and stirring to obtain an active material suspension in a temperature range of 50 to 150° C.; and
3) drying the active material suspension to obtain the active material containing vanadium and antimony at a temperature in the range of 80 to 300° C.;
4) mixing the active material with the support in a solvent.

In the context of the invention, the vanadium precursor and antimony precursor are intended to mean compounds containing vanadium and compounds containing antimony respectively, which may be converted to the vanadium species and anatomy species, such as metal oxide, composite oxide, salt, sulfate, phosphate, vanadate, antimonate, etc.

Typical vanadium precursor can be at least one of ammonium vanadate, vanadium oxalate, vanadyl oxalate, vanadium oxides (e.g. vanadium pentoxide), vanadium monoethanolamine, vanadium chloride, vanadium trichloride oxide, vanadyl sulfate, vanadium sulfate, vanadium antimonite, vanadium antimonate and vanadium oxides.

Typical antimony precursor can be at least one of antimony acetate, ethylene glycol antimony (antimony ethylene glycoxide), antimony sulfate, antimony nitrate, antimony chloride, antimonous sulfide, antimony oxides (e.g. Sb₂O₃) and antimony vanadate.

In one or more embodiments, the drying in step 3) is preferably conducted at a temperature in the range of 100° C. to 250° C., more preferably 110° C. to 180° C. The drying can be conducted in any ways known in the art without particular limitations.

In one or more embodiments, the mixture from step 4), which may be dry or wet, may be prepared in various ways known in the art, depending on the precursors to be used in this step. For example, the wet mixture may be prepared by incipient wetness impregnation techniques, also called capillary impregnation or dry impregnation. In a particular embodiment, the wet mixture is prepared by a method comprising preparation of a mixture of support and Sb₂O₃ and then incorporating a solution of vanadium precursor via incipient wetness impregnation.

### SCR Catalytic Article

The present invention also provides an SCR catalytic article comprising an SCR catalyst described above, the SCR catalyst is applied onto a substrate having a monolithic structure.

The substrate is not particularly limited, and for example, a flow-through substrate or a wall-flow substrate. The substrate may be any of those materials typically used for preparing such catalysts, such as ceramic or metal, and will preferably have a ceramic honeycomb structure. Any suitable substrates may be employed, such as a monolithic substrate of the type having fine, parallel gas flow passages extending therethrough from an inlet or an outlet face of the substrate, such that passages are open to fluid flow therethrough (i.e., flow-through substrates). The passages, which are essentially straight paths from their fluid inlet to their fluid outlet, are defined by walls on which the catalytic material is applied as a washcoat so that the gases flowing through the passages contact the catalytic material. The flow passages of the monolithic substrate are thin-walled channels, which can be of any suitable cross-sectional shape and size, such as trapezoidal, rectangular, square, sinusoidal, hexagonal, oval, circular, etc.

Such monolithic substrates may contain up to about 900 or more flow passages (or “cells”) per square inch of cross section, although far fewer may be used. For example, the substrates may have about 50 to 600, more usually about 200 to 600, and most usually about 300 to 600 cells per square inch (“cpsi”).

In some embodiments, the load of the SCR catalyst on the substrate is generally in the range of 0.5 to 10 g/in³, preferably 1 to 7 g/in³, and more preferably 2 to 5.5 g/in³.

Alternatively, the SCR catalyst may be shaped into beads, spheres, pellets, or honeycomb bodies and the like, according to various techniques known in the art. Any conventional auxiliaries may be incorporated during the shaping process as desired, such as binders, fillers and/or plasticizers. It is to be understood that the shaped bodies will be dried and calcined so as to be ready for service.

In one or more embodiments, the SCR catalyst is shaped into a honeycomb body by extrusion, dried and calcined to provide the finished catalysts in form of extruded honeycomb bodies. Such catalysts in form of extruded honeycomb bodies contain the catalytic material itself as the skeleton without an additional inert substrate. By dispensing the use of inert substrate, significantly more amount of catalytic material per volume of the catalyst body is available and thus better NOx abatement performance may be provided especially at low temperatures, compared with the finished catalysts in form of coated substrate.

In some embodiments, the extruded SCR catalytic article further comprises at least one binder and/or matrix material and/or the precursors thereof. The binder and/or matrix components may improve the mechanical strength of the final extruded products. The binder and/or matrix materials can be, but not limited to, selected from cordierite, nitrides, carbides, borides, intermetallic, aluminosilicate, spinel, alumina and/or doped alumina, silica, titania, zirconia, titania-zirconia, glass fiber and mixtures of any two or more thereof.

In some embodiments, the extruded SCR catalytic article may be prepared by a process, in which additives such as plasticizer and/or dispersant and/or acid and/or pore forming agent, etc., can be added.

In specific embodiments of extruded SCR catalytic articles with matrix materials, the vanadium, calculated as V₂O₅, is present in the extruded SCR catalytic article in an amount of 0.5 to 15% by weight, relative to the total weight of the extruded SCR catalytic article.

In specific embodiments of extruded SCR catalytic articles with matrix materials, the antimony, calculated as Sb₂O₃, is present in the extruded SCR catalytic article in an amount of 0.25 to 20% by weight, relative to the total weight of the extruded SCR catalytic article.

In some embodiments, the SCR catalyst on the substrate, or the extruded SCR catalyst is then dried at a temperature in the range of −20° C. to 300° C., preferably 20° C. to 250° C., more preferably 20° C. to 200° C. The drying can be conducted in any ways known in the art without particular limitations.

In some embodiments, the SCR catalyst on the substrate, or the extruded SCR catalyst after drying is further calcinated at a temperature of from 350° C. to 700° C., preferably in the range of 400° C. to 700° C., more preferably 450° C. to 600° C., 500° C. and 550° C. included.

Generally, the calcination is generally conducted for a period of no more than 5 hours, particularly no more than 3 hours, for example 0.5 or 1 or 2 hours in the case that the finished catalysts are in form of coated substrate, and for a period of no more than 20 hours, particularly no more than 10 hours, for example 1, 2, 3, 4, 5, 6, 7, 8, or 9 hours in the case that the finished catalysts are in a form of shaped bodies.

### Method for Treatment of Exhaust Gas from an Internal Combustion Engine

In a further aspect, the present invention relates to a method for treatment of exhaust gas from an internal combustion engine comprising:
(1) an SCR catalyst described above,
(2) flowing the exhaust gas from the engine through the SCR catalyst, and
(3) optionally in the presence of a reductant.

The exhaust gases which can be treated by the SCR catalysts according to the present invention are any exhaust gases containing NOx to be removed or reduced. The exhaust gases are from for example, but not limited to an internal combustion engine such as lean-burn engines, diesel engines, natural gas engines, power plants, incinerators, generator sets, or gasoline engines.

In one or more embodiments, the exhaust gases are contacted with the SCR catalysts according to the present invention at a temperature in the range of 150° C. to 650° C., or 170 to 625° C., or 180 to 600° C., or 200 to 550° C., 250° C., 300° C., 350° C., 400° C., 450° C. and 500° C. included.

The contact of the exhaust gases with the SCR catalysts according to the present invention is conducted in the presence of a reductant. The reductant that can be used in the present invention may be any reductants known in the art per se for reducing NOx, for example NH₃. NH₃ may be derived from urea.

### Method for Testing NOx Conversion

In a further aspect, the present invention relates to a method for testing NOx conversion comprising contacting an exhaust gas comprising NOx with a reductant in the presence of an SCR catalyst described above, the method selectively reduces at least a portion of the NOx to N₂ and H₂O.

### Exhaust Treatment System

In a further aspect, the present invention relates to an exhaust treatment system for an internal combustion engine comprising a reductant injector, and an SCR catalyst described above.

In one or more embodiments, the exhaust treatment system further comprises at least one catalyst selected from a Diesel Oxidation Catalyst (DOC), a Catalyzed Soot Filter (CSF), and an Ammonia Oxidation Catalyst (AMOx).

Oxidation catalysts comprising a precious metal, such as one or more platinum group metals (PGMs), dispersed on a refractory metal oxide support, such as alumina, are known for use in treating the exhaust of diesel engines in order to convert both hydrocarbon and carbon monoxide gaseous pollutants by catalyzing the oxidation of these pollutants to carbon dioxide and water. Such catalysts have been generally contained in units called diesel oxidation catalysts (DOC), which are placed in the exhaust flow path from diesel engines to treat the exhaust before it vents to the atmosphere. Typically, the diesel oxidation catalysts are formed on ceramic or metallic substrates upon which one or more catalyst coating compositions are deposited. In addition to the conversion of gaseous HC and CO emissions and particulate matter (SOF portion), oxidation catalysts that contain one or more PGMs promote the oxidation of NO to NO₂.

As used herein, the term of “DOC” refers to a diesel oxidation catalyst, which controls emissions of HC and CO from diesel vehicles. The DOC catalyst mainly contains PGM, alumina, zeolite and titania on ceramic or metallic substrates, preferably contain Pt and/or Pd, alumina and/or titania, as well as optionally silica as additives on ceramic or metallic substrates.

In addition to the use of the DOC catalysts, particulate filters are used to achieve high particulate matter reduction in exhaust treatment systems. Known filter structures that remove particulate matter from exhaust include honeycomb wall flow filters, wound or packed fiber filters, open cell foams, sintered metal filters, etc. These filters can remove over 90% of the particulate material from the exhaust.

In some embodiments, the soot filter is coated with a catalyst to promote soot combustion and thereby promoting filter regeneration. In one or more embodiments, the soot filter is coated with a catalyst to promote NOx conversion. In one or more embodiments, the soot filter is coated with a catalyst to have at least one function of CO oxidation, hydrocarbon storage, hydrocarbon oxidation, NOx storage, NO oxidation, and fuel light-off.

Ammonia slip from the ammonia-SCR catalyst presents a number of problems. The odor thresh-old for NH₃ is 20 ppm in air. Eye and throat irritation are noticeable above 100 ppm, skin irritation occurs above 400 ppm, and the IDLH is 500 ppm in air. NH₃ is caustic, especially in its aqueous form. Condensation of NH₃ and water in cooler regions of the exhaust line downstream of the exhaust catalysts will give a corrosive mixture. Therefore, it is desirable to eliminate the ammonia before it can slip out of the tailpipe.

A selective ammonia oxidation catalyst (AMOx) is employed for this purpose, with the objective to convert the excess ammonia to N₂. It is desirable to provide a catalyst for selective ammonia oxidation that is able to convert ammonia at a wide range of temperatures where ammonia slip occurs in the vehicles driving cycle, and can produce minimal nitrogen oxide byproducts. The AMOx catalyst should also produce minimal N₂O, which is a potent greenhouse gas. An ammonia oxidation catalyst or AMOx refers to a catalyst that promotes the oxidation of NH₃. Preferably, the ammonia oxidation catalyst (AMOx) is used to convert ammonia to N₂ as major product, and to produce minimal nitrogen oxide byproducts.

In some embodiments, the SCR catalyst can optionally be integrated with other functions such as DOC, CSF, AMOx, CO oxidation, hydrocarbon storage, hydrocarbon oxidation, NOx storage, NO oxidation, etc. as one catalyst or in one “brick”.

In some embodiments, the SCR catalyst can optionally be integrated with other functions as one catalyst or in one “brick” via different layouts (zoning, layering, homogeneous, etc.).

As used herein, the term “brick” refers to a single article such as a monolith, such as flow through monolith or a filter, such as wall flow filter.

### Embodiments

The invention will be further illustrated by following embodiments, which set forth particularly advantageous embodiments. While the embodiments are provided to illustrate the present invention, they are not intended to limit it.
1. An SCR catalyst for reduction of nitrogen oxides, comprising: a support, and an active material on the support;
   wherein the support, calculated as its oxide, is present in the SCR catalyst in an amount of 40 to 99% by weight, relative to the total weight of the SCR catalyst;
   wherein the active material comprises vanadium and antimony, the vanadium, calculated as V₂O₅, is present in the SCR catalyst in an amount of 1 to 15% by weight, relative to the total weight of the SCR catalyst and the antimony, calculated as Sb₂O₃, is present in the SCR catalyst in an amount of 0.5 to 20% by weight, relative to the total weight of the SCR catalyst;
   wherein the SCR catalyst, after hydrothermally aged at 550° C. for 100 hours with 10% water, has a 200-300° C. denitrification efficiency of at least 60%, with 60,000 h⁻¹ space velocity and an ammonia to NOx molar ratio of 1:1.
2. The SCR catalyst according to embodiment 1, wherein the support comprises a metal oxide of Ti, Si, W, Al, Ce, Zr, Mg, Ca, Ba, Y, La, Pr, Nb, Mo, Mn, Fe, Co, Ni, Cu, Zn, Ga, Sn, Bi, or a mixture of any two or more of the metal oxides, or a molecular sieve.
3. The SCR catalyst according to embodiment 2, wherein the support comprises TiO₂, and/or SiO₂.
4. The SCR catalyst according to embodiment 3, wherein the support comprises TiO₂ and SiO₂, the SiO₂, is present in an amount of 1 to 20% by weight, preferably 2.5 to 15% by weight, and more preferably 3 to 10% by weight, relative to the total weight of the support.
5. The SCR catalyst according to any one of embodiments 1 to 4, wherein the support calculated as its oxide, is present in the SCR catalyst in an amount of 50 to 90% by weight, relative to the total weight of the SCR catalyst.
6. The SCR catalyst according to embodiment 5, wherein the support calculated as metal oxide or molecular sieve, is present in the SCR catalyst in an amount of 60 to 85% by weight, relative to the total weight of the SCR catalyst.
7. The SCR catalyst according to any one of embodiments 1 to 6, wherein the vanadium, calculated as V₂O₅, is present in the SCR catalyst in an amount of 4 to 12% by weight, relative to the total weight of the SCR catalyst.
8. The SCR catalyst according to embodiment 7, wherein the vanadium, calculated as V₂O₅, is present in the SCR catalyst in an amount of 5 to 10% by weight, relative to the total weight of the SCR catalyst.
9. The SCR catalyst according to any one of embodiments 1 to 8, wherein the antimony, calculated as Sb₂O₃, is present in the SCR catalyst in an amount of 3 to 16% by weight, relative to the total weight of the SCR catalyst.
10. The SCR catalyst according to embodiment 9, wherein the antimony, calculated as Sb₂O₃, is present in the SCR catalyst in an amount of 4 to 14% by weight, relative to the total weight of the SCR catalyst.
11. The SCR catalyst according to any one of embodiments 1 to 10, wherein the active material has a V/Sb molar ratio of from 8:1 to 1:8, preferably from 4:1 to 1:4, more preferably from 2:1 to 1:2, calculated as respective elements.
12. A method for preparing the SCR catalyst according to any one of embodiments 1 to 11, comprising steps of:
   1) adding an antimony precursor in DI water, and stirring to obtain an antimony suspension in a temperature range of 50 to 150° C.;
   2) adding a vanadium precursor into the antimony suspension obtained in step 1), and stirring to obtain an active material suspension in a temperature range of 50 to 150° C.:
   3) drying the active material suspension to obtain the active material containing vanadium and antimony at a temperature in the range of 80 to 300° C.; and
   4) mixing the active material with the support in a solvent.
13. An SCR catalytic article comprising an SCR catalyst according to any one of embodiments 1 to 11, wherein the SCR catalyst is applied onto a substrate having a monolithic structure.
14. The SCR catalytic article according to embodiment 13, wherein the load of the SCR catalyst on the substrate is in the range of 0.5 to 10 g/in³, preferably 1 to 7 g/in³, and more preferably 2 to 5.5 g/in³.
15. An SCR catalytic article comprising an SCR catalyst according to any one of embodiments 1 to 11, wherein the SCR catalyst further comprises a matrix material, the SCR catalyst is shaped into a honeycomb body by extrusion.
16. A method for treatment of exhaust gas from an internal combustion engine comprising:
   (1) an SCR catalyst according to any one of embodiments 1 to 11,
   (2) flowing the exhaust gas from the engine through the SCR catalyst, and
   (3) in the presence of a reductant.
17. A method for testing NOx conversion, comprising: contacting an exhaust gas comprising NOx with a reductant in the presence of an SCR catalyst according to any one of embodiments 1 to 11, wherein the method selectively reduces at least a portion of the NOx to N₂ and H₂O.
18. An exhaust treatment system for an internal combustion engine comprising a reductant injector, an SCR catalyst according to any one of embodiments 1 to 11.
19. The exhaust treatment system for an internal combustion engine according to embodiment 18 further comprises at least one catalyst selected from a Diesel Oxidation Catalyst (DOC), a Catalyzed Soot Filter (CSF), and an Ammonia Oxidation Catalyst (AMOx).

### EXAMPLES

The invention will be further illustrated by following Examples, which set forth particularly advantageous embodiments. While the Examples are provided to illustrate the present invention, they are not intended to limit it.

### Example 1

177.14 g Sb₂O₃ was added in 800 g DI water, and stirring for 2 hours to obtain an antimony suspension at 120° C., then 110.51 g V₂O₅ was added, and stirring for another 12 hour to obtain an active material suspension. Dried the active material suspension at 250° C. to obtain active material 1 containing vanadium and antimony. 6.8 g active material 1 and 88.5 g SiO₂/TiO₂ support (5% SiO₂) were mixed and formed slurry in DI water, and stirred for 30 minutes. 30% aqueous ammonia solution was added dropwise to the suspension to obtain a pH of 7.0, and then 11.5 g aqueous colloidal SiO₂ solution (40% SiO₂ solid) was added. After stirring for 1 hour, a homogenous slurry was obtained. Then a flow through honeycomb cordierite substrate of 300 cpsi with a wall thickness of 5 mils was dipped into the obtained slurry to load enough slurry. Dried with hot air at 150° C. for 15 minutes and then calcining at 550° C. for 1 hour in air. After cooling to room temperature, the SCR catalytic article was further treated at 550° C. in 10% steam/air for 100 hours. After cooling to room temperature, SCR catalytic article 1 with an SCR catalyst containing 2.5% V₂O₅ was obtained. The total loading of washcoat on the substrate is 3.0 g/in³.

### Example 2

The synthesis procedure for SCR catalytic article 2 was analogous to that of SCR catalytic article in Example 1, except that the amounts of SiO₂/TiO₂ powder and active material 1 were adjusted to 79.5 g and 10.8 g respectively. After cooling to room temperature, SCR catalytic article 2 with an SCR catalyst containing 4.0% V₂O₅ was obtained. The total loading of washcoat on the substrate is 4.5 g/in.

### Example 3

The synthesis procedure for SCR catalytic article 3 was analogous to that of SCR catalytic article in Example 1, except that the amounts of SiO₂/TiO₂ powder and active material 1 were adjusted to 76.8 g and 13.5 g respectively. After cooling to room temperature, SCR catalytic article 3 with an SCR catalyst containing 5.0% V₂O₅ was obtained. The total loading of washcoat on the substrate is 4.5 g/in.

### Example 4

The synthesis procedure for SCR catalytic article 4 was analogous to that of SCR catalytic article in Example 1, except that the amounts of SiO₂/TiO₂ powder and active material 1 were adjusted to 74.1 g and 16.2 g respectively. After cooling to room temperature, SCR catalytic article 4 with an SCR catalyst containing 6.0% V₂O₅ was obtained. The total loading of washcoat on the substrate is 4.5 g/in³.

### Example 5

The synthesis procedure for SCR catalytic article 5 was analogous to that of SCR catalytic article in Example 1 except that the amounts of SiO₂/TiO₂ powder and active material 1 were adjusted to 76.4 g and 19.0 g respectively. No further treatment at 550° C. in 10% steam/air for 100 hours was applied. After cooling to room temperature, SCR catalytic article 5 with SCR catalyst containing 7.0% V₂O₅ was obtained. The total loading of washcoat on the substrate is 3.0 g/in³.

### Example 6

SCR catalytic article 5 was further treated at 550° C. in 10% steam/air for 100 hours. After cooling to room temperature, SCR catalytic article 6 was obtained. The total loading of washcoat on the substrate is 3.0 g/in³.

### Example 7

SCR catalytic article 5 was further treated at 600° C. in air for 50 hours. After cooling to room temperature, SCR catalytic article 7 was obtained. The total loading of washcoat on the substrate is 3.0 g/in³.

### Example 8

The synthesis procedure for SCR catalytic article 8 was analogous to that of the SCR catalytic article in Example 5 except that the amounts of SiO₂/TiO₂ powder and active material 1 were adjusted to 63.3 g and 27.0 g respectively. After cooling to room temperature, SCR catalytic article 8 with SCR catalyst containing 10.0% V₂O₅ was obtained.

The total loading of washcoat on the substrate is 3.0 g/in³.

### Example 9

SCR catalytic article 8 was further treated at 550° C. in 10% steam/air for 100 hours. After cooling to room temperature, SCR catalytic article 9 was obtained. The total loading of washcoat on the substrate is 3.0 g/in³.

### Example 10 (Comparative Example 1)

86.8 g SiO₂/TiO₂ support, 23.8 g vanadyl oxalate solution with 10.5% V₂O₅ content and 3.8 g Sb₂O₃ were mixed in 100 g DI water at room temperature. After keep stirring the suspension for 30 minutes, 30% aqueous ammonia solution was further added to raise to suspension system pH to 6.0 & 7.0. Then 23.2 g SiO₂ sol with 30% SiO₂ content was finally added. After stirring for 1 hour, a homogenous slurry was obtained. Then a flow through honeycomb cordierite substrate of 300 cpsi with a wall thickness of 5 mils was dipped into the obtained slurry to load enough slurry. Dried with hot air at 150° C. for 15 minutes and then calcining at 550° C. for 1 hours in air. After cooling to room temperature, the SCR catalytic article was further treated at 550° C. in 10% steam/air for 100 hours. After cooling to room temperature, a comparative SCR catalytic article with SCR catalyst containing 2.5% V₂O₅ was obtained. The total loading of washcoat on the substrate is 3.0 g/in³.

### Example 11 (Comparative Example 2)

The synthesis procedure for Comparative SCR catalytic article 2 was analogous to that of SCR catalytic article in Comparative Example 1 except that the amounts of SiO₂/TiO₂ powder, vanadyl oxalate solution and Sb₂O₃ were adjusted to 83.1 g, 38.1 g and 6.0 g respectively. After cooling to room temperature, Comparative SCR catalytic article 2 with SCR catalyst containing 4.0% V₂O₅ was obtained. The total loading of washcoat on the substrate is 4.5 g/in³.

### Example 12 (Comparative Example 3)

The synthesis procedure for Comparative SCR catalytic article 3 was analogous to that of SCR catalytic article in Comparative Example 1 except that the amounts of SiO₂/TiO₂ powder, vanadyl oxalate solution and Sb₂O₃ were adjusted to 80.5 g, 47.6 g and 7.5 g respectively. After cooling to room temperature, Comparative SCR catalytic article 3 with SCR catalyst containing 5.0% V₂O₅ was obtained. The total loading of washcoat on the substrate is 4.5 g/in³.

### Example 13 (Comparative Example 4)

The synthesis procedure for Comparative SCR catalytic article 4 was analogous to that of SCR catalytic article in Comparative Example 1 except that the amounts of SiO₂/TiO₂ powder, vanadyl oxalate solution and Sb₂O₃ were adjusted to 78.1 g, 57.1 g and 9.0 g respectively. After cooling to room temperature, Comparative SCR catalytic article 4 with SCR catalyst containing 6.0% V₂O₅ was obtained. The total loading of washcoat on the substrate is 4.5 g/in³.

### Example 14 (Comparative Example 5)

The synthesis procedure for Comparative SCR catalytic article 5 was analogous to that of SCR catalytic article in Comparative Example 1 except that the amounts of SiO₂/TiO₂ powder, vanadyl oxalate solution and Sb₂O₃ were adjusted to 75.5 g, 66.7 g and 10.5 g respectively. No further treatment at 550° C. in 10% steam/air for 100 hours was applied. After cooling to room temperature, Comparative SCR catalytic article 5 with SCR catalyst containing 7.0% V₂O₅ was obtained. The total loading of washcoat on the substrate is 3.0 g/in³.

### Example 15 (Comparative Example 6)

Comparative SCR catalytic article 5 was further treated at 550° C. in 10% steam/air for 100 hours. After cooling to room temperature, Comparative SCR catalytic article 6 was obtained. The total loading of washcoat on the substrate is 3.0 g/in³.

### Example 16 (Comparative Example 7)

Comparative SCR catalytic article 5 was further treated at 600° C. in air for 50 hours. After cooling to room temperature, Comparative SCR catalytic article 7 was obtained. The total loading of washcoat on the substrate is 3.0 g/in³.

### Example 17 (Comparative Example 8)

The synthesis procedure for Comparative SCR catalytic article 8 was analogous to that of SCR catalytic article in Comparative Example 5 except that the amounts of SiO₂/TiO₂ powder, vanadyl oxalate solution and Sb₂O₃ were adjusted to 68.1 g, 95.2 g and 15.5 g respectively. After cooling to room temperature, Comparative SCR catalytic article 8 with SCR catalyst containing 10.0% V₂O₅ was obtained. The total loading of washcoat on the substrate is 3.0 g/in³.

### Example 18 (Comparative Example 9)

Comparative SCR catalytic article 8 was further treated at 550° C. in 10% steam/air for 100 hours. After cooling to room temperature, Comparative SCR catalytic article 9 was obtained. The total loading of washcoat on the substrate is 3.0 g/in³.

### SCR Performance Test of SCR Catalytic Articles from Examples 1 to 9 and Comparative Examples 1 to 9

A sample with diameter of 1 inch and length of 4 inches was cut down from the core of each SCR catalytic article as prepared in Examples 1 to 9 and Comparative Examples 1 to 9. Each sample was placed in a laboratory fixed-bed simulator. The feed gas consists of, by volume, 10% H₂O, 5% 02, 500 ppm NO, 500 ppm NH₃ and a balance of N₂, and was supplied at a space velocity of 60,000 h. The SCR performance test results are summarized in Table 1 below.

The SCR performance was characterized by the conversion of NOx, which was calculated according to the following equation.

Conversion of NOx=(NOxᵢₙₗₑₜ−NOxₒᵤₜₗₑₜ)/NOxᵢₙₗₑₜ×100%

TABLE 1

| | Conversion of | Conversion of |
|---|---|---|
| SCR catalytic articles | NOx, 200° C. | NOx, 500° C. |
| Example 1 | 5.3 | 77.1 |
| Example 2 | 64.2 | 80.1 |
| Example 3 | 63.8 | 84.2 |
| Example 4 | 65.7 | 82.3 |
| Example 5 | 60.0 | 92.7 |
| Example 6 | 64.5 | 82.6 |
| Example 7 | 52.4 | 82.5 |
| Example 8 | 62.1 | 82.0 |
| Example 9 | 61.5 | 66.7 |
| Comparative Example 1 | 12.9 | 87.5 |
| Comparative Example 2 | 57.5 | 86.7 |
| Comparative Example 3 | 58.7 | 78.9 |
| Comparative Example 4 | 58.4 | 73.9 |
| Comparative Example 5 | 49.9 | 62.9 |
| Comparative Example 6 | 48.6 | 64.2 |
| Comparative Example 7 | 38.9 | 62.3 |
| Comparative Example 8 | 53.3 | 48.0 |
| Comparative Example 9 | 16.6 | 14.7 |

It can be seen from the results shown in Table 1, significantly higher conversions of NOx at 200° C. were achieved with the catalysts of Examples 2 to 9 containing no less than 4% V₂O₅, compared with the catalysts of Comparative Examples 2 to 9.

1-19. (canceled)

20. An SCR catalyst for reduction of nitrogen oxides, comprising: a support, and an active material on the support;
wherein the support, calculated as its oxide, is present in the SCR catalyst in an amount ranging from 40% to 99% by weight, relative to a total weight of the SCR catalyst;
wherein the active material comprises vanadium and antimony, the vanadium, calculated as V₂O₅, is present in the SCR catalyst in an amount ranging from 1% to 15% by weight, relative to the total weight of the SCR catalyst and the antimony, calculated as Sb₂O₃, is present in the SCR catalyst in an amount ranging from 0.5% to 20% by weight, relative to the total weight of the SCR catalyst;
wherein the SCR catalyst, after hydrothermally aged at 550° C. for 100 hours with 10% water, has a 200° C.-300° C. denitrification efficiency of at least 60%, with 60,000 h⁻¹ space velocity and an ammonia to NOx molar ratio of 1:1.

21. The SCR catalyst according to claim 20, wherein the support comprises a metal oxide of Ti, Si, W, Al, Ce, Zr, Mg, Ca, Ba, Y, La, Pr, Nb, Mo, Mn, Fe, Co, Ni, Cu, Zn, Ga, Sn, Bi, or a mixture of any two or more of the metal oxides, or a molecular sieve.

22. The SCR catalyst according to claim 21, wherein the support comprises TiO₂, and/or SiO₂.

23. The SCR catalyst according to claim 22, wherein the support comprises TiO₂ and SiO₂, the SiO₂, is present in an amount ranging from 1% to 20% by weight, relative to the total weight of the support.

24. The SCR catalyst according to claim 20, wherein the support calculated as its oxide, is present in the SCR catalyst in an amount ranging from 50% to 90% by weight, relative to the total weight of the SCR catalyst.

25. The SCR catalyst according to claim 24, wherein the support calculated as metal oxide or molecular sieve, is present in the SCR catalyst in an amount ranging from 60% to 85% by weight, relative to the total weight of the SCR catalyst.

26. The SCR catalyst according to claim 20, wherein the vanadium, calculated as V₂O₅, is present in the SCR catalyst in an amount ranging from 4% to 12% by weight, relative to the total weight of the SCR catalyst.

27. The SCR catalyst according to claim 26, wherein the vanadium, calculated as V₂O₅, is present in the SCR catalyst in an amount ranging from 5% to 10% by weight, relative to the total weight of the SCR catalyst.

28. The SCR catalyst according to claim 20, wherein the antimony, calculated as Sb₂O₃, is present in the SCR catalyst in an amount ranging from 3% to 16% by weight, relative to the total weight of the SCR catalyst.

29. The SCR catalyst according to claim 28, wherein the antimony, calculated as Sb₂O₃, is present in the SCR catalyst in an amount ranging from 4% to 14% by weight, relative to the total weight of the SCR catalyst.

30. The SCR catalyst according to claim 20, wherein the active material has a V/Sb molar ratio of from 8:1 to 1:8, calculated as respective elements.

31. A method for preparing the SCR catalyst according to claim 20, comprising steps of:
1) adding an antimony precursor in deionized water, and stirring to obtain an antimony suspension in a temperature ranging from 50° C. to 150° C.;
2) adding a vanadium precursor into the antimony suspension obtained in step 1), and stirring to obtain an active material suspension in a temperature ranging from 50° C. to 150° C.; and
3) drying the active material suspension to obtain the active material containing vanadium and antimony at a temperature ranging from of 80° C. to 300° C.; and
4) mixing the active material with the support in a solvent.

31. An SCR catalytic article comprising an SCR catalyst according to claim 20, wherein the SCR catalyst is applied onto a substrate having a monolithic structure.

32. The SCR catalytic article according to claim 31, wherein the load of the SCR catalyst on the substrate ranges from 0.5 g/in³ to 10 g/in³.

33. An SCR catalytic article comprising an SCR catalyst according to claim 20, wherein the SCR catalyst further comprises a matrix material, the SCR catalyst is shaped into a honeycomb body by extrusion.

34. A method for treatment of exhaust gas from an internal combustion engine comprising:
(1) an SCR catalyst according to claim 20;
(2) flowing the exhaust gas from the engine through the SCR catalyst; and
(3) in the presence of a reductant.

35. A method for testing NOx conversion, comprising: contacting an exhaust gas comprising NOx with a reductant in the presence of an SCR catalyst according to claim 20, wherein the method selectively reduces at least a portion of the NOx to N₂ and H₂O.

36. An exhaust treatment system for an internal combustion engine comprising a reductant injector, and the SCR catalyst according to claim 20.

37. The exhaust treatment system for an internal combustion engine according to claim 36, further comprises at least one catalyst selected from a Diesel Oxidation Catalyst (DOC), a Catalyzed Soot Filter (CSF), and an Ammonia Oxidation Catalyst (AMOx).
